(19) United States
(12) Patent Application Publication
(10) Pub. No.: US 2026/0355776 A1
(43) Pub. Date: Nov. 12, 2026

(54) PAINT SPRAY GUN HAVING AN INTEGRATED TOOL

(71) Applicant: SATA GmbH & Co. KG, Kornwestheim (DE)

(72) Inventor: Alexander TSCHAN, Kornwestheim (DE)

(73) Assignee: SATA GmbH & Co. KG, Kornwestheim (DE)

(21) Appl. No.: 19/489,575

(22) PCT Filed: Dec. 13, 2024
(86) PCT No.: PCT/EP2024/086107

§ 371 Date: Dec. 2, 2025

(30) Foreign Application Priority Data
Dec. 18, 2023 (DE) 10 2023 135 503.1

(51) Int. Cl. B05B 15/65; B05B 7/02; B05B 12/00

(52) U.S. Cl. CPC B05B 15/65; B05B 7/02; B05B 12/002

(57) ABSTRACT

A paint spray gun includes: a paint spray gun body; a paint nozzle body which can be detachably fixed to the paint spray gun body; and a trigger element which is designed to be detachably connected to the paint spray gun body. The trigger element has a tool inner contour and the paint nozzle body has a workpiece outer contour corresponding to the tool inner contour of the trigger element. The trigger element is designed to be removed from the paint spray gun body; and the tool inner contour is designed to be brought into engagement with the workpiece outer contour of the paint nozzle body in such a way that the paint nozzle body can be removed from the paint spray gun body and/or the paint nozzle body can be mounted on the paint spray gun body.

### FIELD OF THE INVENTION

The invention relates to a paint spray gun, a trigger element for a paint spray gun having a paint spray gun body and a paint nozzle body, a use of a trigger element with a tool inner contour for mounting and/or removing a paint nozzle body to and/or from a paint spray gun, a use of a paint nozzle body in a paint spray gun, and a paint nozzle body for a paint spray gun.

### BACKGROUND

Paint spray guns are generally known in the prior art and are used for example in automotive workshops for painting cars. Paint spray guns are used to atomize flowable material and apply it to a surface. The material to be applied can be liquid and in powder form. The paint spray guns can be equipped with different paint nozzles. These paint nozzles can in particular have different opening diameters and/or different geometries, in particular outlet geometries, in order to achieve for example different material throughputs and/or to generate different jet shapes. By changing from one paint nozzle with a specific diameter and/or a specific geometry, in particular outlet geometry, to another paint nozzle with a different diameter and/or a different geometry, in particular outlet geometry, the material throughput and/or the jet shape can be changed. These changes require special tools.

In this context, it has now become apparent that there is a further need to provide a paint spray gun; in particular, there is a need to provide a paint spray gun with an efficient and cost-effective option for changing the paint nozzle.

### SUMMARY OF THE INVENTION

These and other objects mentioned upon reading the following description or which may be recognized by a person skilled in the art are achieved by the subject matter of the independent claims. The dependent claims develop the central idea of the present invention in a particularly advantageous manner.

In accordance with a first aspect of the present invention, a paint spray gun is provided, comprising: a paint spray gun body; a paint nozzle body which can be detachably fixed to the paint spray gun body; a trigger element which is designed to be detachably connected to the paint spray gun body; wherein the trigger element has a tool inner contour; wherein the paint nozzle body has a workpiece outer contour corresponding to the tool inner contour of the trigger element; wherein the trigger element is designed to be removed from the paint spray gun body; and wherein the tool inner contour is designed to be brought into engagement with the workpiece outer contour of the paint nozzle body in such a way that the paint nozzle body can be removed from the paint spray gun body and/or the paint nozzle body can be mounted on the paint spray gun body.

In accordance with a further aspect of the present invention, a paint nozzle body for a paint spray gun is provided, which body has an outlet opening, wherein the paint nozzle body has a workpiece outer contour, wherein the workpiece outer contour has at least four, in particular six, recesses for receiving a tool.

The following statements can apply to the paint spray gun according to the invention and to the paint nozzle body according to the invention. The paint nozzle body according to the invention can be used in the paint spray gun according to the invention.

The term “paint spray gun” refers in particular to a hand-held paint application unit with a trigger handle for actuating one or more valves designed to release a paint flow and, if applicable, an air flow. The terms “paint spray gun,” “paint nozzle,” or other designations containing the terms “varnish” or “paint” are not to be understood as limiting to these materials. With the paint spray gun according to the invention, for example, paint, adhesive or varnish, in particular base and clear varnish, both solvent-based and water-based, can be sprayed, as well as liquids for the food industry, wood preservatives or other liquids. Handheld paint spray guns are mainly used by craftsmen, in particular painters, carpenters and varnishers. However, it is also conceivable to integrate a hand-held paint spray gun into a painting robot or a painting machine. In particular, a paint spray gun according to the invention designed as a hand-held paint spray gun can be designed as a gravity flow cup gun with a paint cup arranged above the paint spray gun body, from which the material to be sprayed flows into and through the paint channels substantially by gravity and by negative pressure at the front end of the paint nozzle. The paint spray gun according to the invention can be a side cup gun in which the paint cup is arranged on the side of the paint spray gun body and in which the material is also fed by gravity and by negative pressure at the front end of the material nozzle of the gun. The paint spray gun according to the invention can be designed as a suction or hanging cup spray gun with a paint cup arranged below the paint spray gun body, from which the material to be sprayed is suctioned out of the cup substantially by negative pressure. The paint spray gun according to the invention can be designed as a pressure cup gun, in which the cup is arranged below, above or to the side of the paint spray gun body and is subjected to pressure, whereupon the material to be sprayed is pressed out of the cup. The paint spray gun according to the invention can be a pressure fed spray gun in which the material to be sprayed is fed to the spray gun by means of a hose from a paint container or via a pump. The paint spray gun according to the invention can be a low-pressure gun, in particular an HVLP gun, with an internal nozzle pressure of at most 10 psi or 0.7 bar, whereby transfer rates of more than 65% are achieved. However, it can also be a compliant gun that has an internal nozzle pressure of more than 10 psi or 0.7 bar, but also achieves a transfer rate of more than 65%. The paint spray gun according to the invention can be a compressed air atomizing paint spray gun. The paint spray gun according to the invention can be an air-assisted paint spray gun. The paint spray gun according to the invention can be an airless gun. The paint spray gun according to the invention can be a paint spray gun for powder coating. The paint spray gun according to the invention can be an electrostatic gun. The paint spray gun according to the invention can be a rotary atomizer. The paint spray gun according to the invention can be a different type of paint spray gun.

The term “paint spray gun body” refers in particular to a housing that is designed to arrange the components of a paint spray gun relative to one another and to at least partially enclose them. The paint spray gun body has in particular a handle. The paint spray gun can have a compressed air connection, a paint needle, a trigger for opening an air valve and for moving the paint needle out of the outlet opening of the paint nozzle, a fan control device for adjusting the ratio of atomizing air and horn air to shape the paint jet, an air micrometer for adjusting the spray pressure, a material flow regulating device for adjusting the maximum material volume flow, a material connection, paint channels for directing the material to be sprayed from a material inlet to the material outlet opening, a suspension hook and/or an analog or digital pressure measuring device. However, it can also include other components from the prior art. In or on the paint spray gun body there is in particular a needle valve for applying paint and, if necessary, an air valve for releasing compressed air, a compressed air connection and a paint connection. Furthermore, in particular a paint nozzle body is arranged on the paint spray gun body. The paint spray gun body has in particular an interface for the paint nozzle body and the paint nozzle body has a corresponding interface. The interfaces are designed in particular as threads. The paint spray gun body can be made of plastics material or metal.

The term “paint nozzle body” refers in particular to a nozzle (or paint nozzle) which is designed to apply paint with a specific spray pattern. The paint nozzle body has in particular an interface for mounting with the paint spray gun body.

The term “trigger element” means in particular a structural element which is designed to be rotatably mounted on the paint spray gun body and to release the needle valve and, if applicable, the air valve by pressing the trigger element, so that paint and/or compressed air flow through the paint nozzle body or through the air cap. The trigger element is detachably connected to the paint spray gun body. The term detachable here means that the trigger element can be mounted on and removed from the paint spray gun body. This can be done for example using a snap connection. The trigger element can be mounted or removed without tools, for example. The trigger element can be mounted or removed using a tool, for example. The trigger element is preferably designed as a single-armed trigger element. The trigger element preferably has a trigger element body with a finger support, wherein a fastening arm preferably extends only from one side of the trigger element body. This fastening arm is fastened to one side of the paint spray gun body. However, the trigger element can also be designed as a two-armed trigger element in which two fastening arms extend from two opposite sides of the trigger element body, wherein both fastening arms are fastened to opposite sides of the paint spray gun body. At least one arm can be detachably arranged on the trigger element body.

The term “tool inner contour” refers in particular to a hollow body shape which is arranged in the trigger element. The tool inner contour can, for example, be designed as a hexagon socket. The tool inner contour is not limited to the hexagon socket. The tool inner contour can be designed to be continuous, i.e., to extend through the entire thickness of the trigger element. Preferably, the tool inner contour is arranged in the form of a blind hole in the trigger element. The side of the trigger element facing away from the tool inner contour is preferably designed to be continuous at the height of the tool inner contour. As a result, the user's fingers, which rest in this region when the paint spray gun is in operation, are not disturbed by a recess.

The term “workpiece outer contour” refers in particular to the surface of the paint nozzle body, in particular a circumferential surface, in particular a circumferential surface of a substantially cylindrical region of the paint nozzle body. The workpiece outer contour in particular has a geometry that corresponds to the tool inner contour. The workpiece outer contour is for example designed as an external hexagon. The workpiece outer contour is not limited to the external hexagon.

The term “engage” here means that the workpiece outer contour of the paint nozzle body is encompassed with a positive fit by the tool inner contour, so that a torque for mounting or removing to or from the paint spray gun body can be applied to the paint nozzle body.

The present invention is based on the recognition that paint spray guns are operated with a plurality of different paint nozzle bodies. The paint nozzle bodies differ for example in the diameter of the nozzle opening and/or in their geometry, in particular the outlet geometry. The different paint nozzle bodies are usually removed from or mounted on the paint spray gun body using a special tool key. The present invention proposes to integrate the tool for mounting/removing the paint nozzle body into the trigger element of the paint spray gun. As a result, the paint spray gun operator always has the tools for mounting and removing at hand. The trigger element is to be detached from the paint spray gun body without additional tools, in particular via a snap connection. The integration of the tool into the trigger element allows for simple and efficient mounting and removing of the paint nozzle bodies. This can have a positive impact on the efficiency and productivity of painting.

In accordance with one embodiment, the trigger element has a finger support surface and the tool inner contour extends away from a side opposite the finger support surface.

The term “finger support surface” here refers to the point of application of the finger for actuating the trigger element.

In this way, by arranging the tool inner contour on the opposite side of the finger support surface, the finger support surface can be designed to be continuous and thus ergonomic. From an ergonomic point of view, this can have a positive effect on the actuation of the trigger element for painting and/or on the mounting and removing of the paint nozzle body.

In accordance with one embodiment, the trigger element has a first end and a second end, as well as a longitudinal extension length (L) between the first end and the second end, wherein the tool inner contour is arranged away from both the first end and the second end of the trigger element by a distance of at least 25% of the longitudinal extension length (L), in particular at least 30% of the longitudinal extension length (L); in particular is arranged away therefrom at a distance of at least 40% of the longitudinal extension length (L).

In other words, the tool inner contour is situated closer to the middle region of the trigger element.

In this way, lower torques are exerted on the structure of the trigger element when mounting and removing the paint nozzle body. This allows the structure of the trigger element to be designed more easily since it is subject to lower loads. In particular, the tool inner contour is arranged between the first end and the second end of the trigger element at a distance of 50% of the longitudinal extension length (L). In other words, the tool inner contour is arranged exactly in the middle. This can result in ergonomic advantages when applying a torque.

In accordance with one embodiment, the tool inner contour has a non-round, in particular a polygonal, in particular a regular polygonal inner contour and the workpiece outer contour has a corresponding non-round, in particular a polygonal, in particular a regular polygonal outer contour, wherein the inner contour and the corresponding outer contour are designed to be brought into engagement. The non-round outer structure has for example an external hexagon as its shape and the non-round inner structure has for example an internal hexagon as its shape.

In accordance with one embodiment, the tool inner contour has a plurality of protrusions and the workpiece outer contour has a corresponding plurality of recesses, wherein the protrusions and the recesses are designed to be brought into engagement. The protrusions and recesses can be polygonal or curved. In particular, the protrusions and recesses are curved. In particular, a corresponding curvature has a constant radius.

In this way, the production of the workpiece outer contour and the tool inner contour can be simplified, since no complex shapes need to be drilled or milled. This applies in particular to the workpiece outer contour, which is in particular machined from a metal blank. This further applies to the tool inner contour, which is preferably produced indirectly by machining using a corresponding injection-molding tool.

In accordance with another embodiment, the workpiece outer contour has a plurality of protrusions and the tool inner contour has a corresponding plurality of recesses, wherein the protrusions and the recesses are designed to be brought into engagement. The protrusions and recesses can be polygonal or curved. In particular, the protrusions and recesses are curved. In particular, a corresponding curvature has a constant radius.

In particular, the number of protrusions or recesses is at least four, in particular six.

As the number of protrusions or recesses increases, the area of the engagement can be positively increased.

In accordance with one embodiment, the plurality of protrusions is evenly distributed over a circumference of the tool inner contour and the plurality of recesses is evenly distributed over a circumference of the workpiece outer contour, or the plurality of protrusions is evenly distributed over a circumference of the workpiece outer contour and the plurality of recesses is evenly distributed over a circumference of the tool inner contour. For example, four recesses or protrusions are distributed at a 90° angular distance around the circumference of the workpiece outer contour or tool inner contour. For example, six recesses or protrusions are distributed at an angular distance of 60° around the circumference of the workpiece outer contour or tool inner contour.

In this way, due to the even distribution, the force can be evenly introduced into the trigger element, so that load peaks that could damage the structure can be avoided. In one embodiment, the trigger element has stiffening ribs which are connected to an outer region of the tool inner contour.

In this way, the stiffening ribs allow the trigger element to be made in a lightweight construction. This has a positive effect on the weight while maintaining high rigidity.

In one embodiment, the trigger element has a trigger element body with which the tool inner contour is integrally formed in one piece. In other words, the trigger element body and the tool inner contour are made from one piece (e.g., machined, cast or molded). In particular, the trigger element is manufactured by injection molding.

In this way, manufacturing costs can be reduced since no mounting steps are necessary.

In one embodiment, the trigger element body formed integrally with the tool inner contour is made of plastics material, in particular of fiber-reinforced plastics material. In this way, the use of plastics material, in particular fiber-reinforced plastics material, can reduce weight, increase toughness and increase stability.

In one embodiment, the fiber-reinforced plastics material is a polyamide with a fiber content of at least 50%, in particular a PA 66.

In this way, by using polyamide with a fiber content of at least 50%, the weight can be reduced, the toughness increased and the stability increased.

In one embodiment, the paint spray gun body has a snap geometry and the trigger element has a corresponding snap counter-geometry, wherein the snap geometry and the snap counter-geometry are designed for releasing and fixing the trigger element on the paint spray gun body. The snap geometry can be realized for example using a retaining ring arranged in a bolt of the trigger element. The bolt is arranged in the trigger element and is designed to be brought into engagement with a bore in the paint spray gun body. A sleeve, in particular a wear-reducing sleeve, can be arranged in the bore of the paint spray gun body. This sleeve can be designed in such a way, or can consist of such a material, that when the bolt of the trigger element is mounted in the sleeve, less wear occurs than would be the case if the bolt of the trigger element were mounted directly in the bore of the paint spray gun body.

In both cases, a rotatable mounting of the trigger element in the paint spray gun body is enabled. This allows for quick mounting or removing of the trigger element from the paint spray gun body, so that a paint nozzle body change can be carried out quickly. The sleeve can be arranged in the paint spray gun body in a rotationally fixed manner relative to the paint spray gun body; in particular, it can be screwed or pressed into the paint spray gun body. The bolt of the trigger element can be mounted in the sleeve so as to be rotatable about its longitudinal axis.

The recesses of the paint nozzle body can have a stop surface at their end facing away from the outlet opening of the paint nozzle body. This stop surface can serve as a stop for the tool for mounting and/or removing the paint nozzle body to or from the paint spray gun body.

The paint nozzle body can have a first collar radially spaced from the outlet opening of the paint nozzle body. Alternatively or in addition to the aforementioned stop surface, the first collar can serve as a stop for the tool for mounting and/or removing the paint nozzle body to or from the paint spray gun body. The first collar can have another purpose, alternatively or additionally.

In the radial direction, a first notch can be arranged between the outlet opening of the paint nozzle body and the first collar. This can be a kind of trench, in particular a circumferential trench, or channel, in particular a circumferential channel, between the outlet opening and the first collar. The first notch can for example accommodate part of the tool for mounting and/or removing the paint nozzle body to or from the paint spray gun body. The first notch can have another purpose, alternatively or additionally.

The recesses can penetrate the first collar in the radial direction by 50% to 90%. This can mean that the recesses extend through 50% to 90% of the thickness of the first collar. In this way, a secure hold can be ensured for the tool for mounting and/or removing the paint nozzle body to or from the paint spray gun body.

The paint nozzle body can have a second collar radially spaced from the first collar. The second collar can serve, in addition to or alternatively to the stop surfaces and/or the first collar, as a stop for the tool for mounting and/or removing the paint nozzle body to or from the paint spray gun body. The second collar can for example provide a seal between an atomizing air region and a shaping air region of the paint spray gun.

A second notch can be arranged in the radial direction between the first collar and the second collar. This can be a kind of trench, in particular a circumferential trench, or channel, in particular a circumferential channel, between the first collar and the second collar. The second notch can for example accommodate part of the tool for mounting and/or removing the paint nozzle body to or from the paint spray gun body. The second notch can have another purpose, alternatively or additionally. Through-bores, particularly for air, in particular for atomizing air, can be made in the second notch.

Preferably, the recesses have a radius of 1 mm to 2 mm, in particular 1.5 mm, and a height of 0.5 mm to 1.2 mm, in particular 0.8 mm. The radius refers in particular to the floor radius. The height refers in particular to the height of the recesses in the radial direction. The height refers in particular to the depth of the recesses, i.e., how deep the recesses extend in the radial direction into the paint nozzle body. In this way, a secure hold can be ensured for the tool for mounting and/or removing the paint nozzle body to or from the paint spray gun body.

A further aspect relates to a trigger element for a paint spray gun having a paint spray gun body and a paint nozzle body, wherein the trigger element is designed to be detached from the paint spray gun body; wherein the trigger element has a tool inner contour designed to be brought into engagement with a corresponding workpiece outer contour of the paint nozzle body, such that the paint nozzle body can be removed from the paint spray gun body and/or mounted on the paint spray gun body.

A further aspect relates to a use of a trigger element with a tool inner contour for mounting and/or removing a paint nozzle body on and/or from a paint spray gun described in more detail above.

A further aspect relates to a use of a paint nozzle body in a paint spray gun described in more detail above.

The features described above, including those from different embodiments, can also be combined with one another, resulting in synergistic interactions that go beyond the sum of the individual effects.

### BRIEF DESCRIPTION OF THE DRAWINGS

The invention is explained below using exemplary embodiments, which are described with reference to the following figures:

FIG. 1 shows an exemplary paint spray gun according to the invention;

FIG. 2 shows an exemplary trigger element according to the invention; and

FIG. 3 shows an exemplary paint nozzle body according to the invention.

### DETAILED DESCRIPTION

Exemplary embodiments are described and explained below with reference to the figures listed above. Identical reference signs or similar reference sign structures refer to similar components or those that interact.

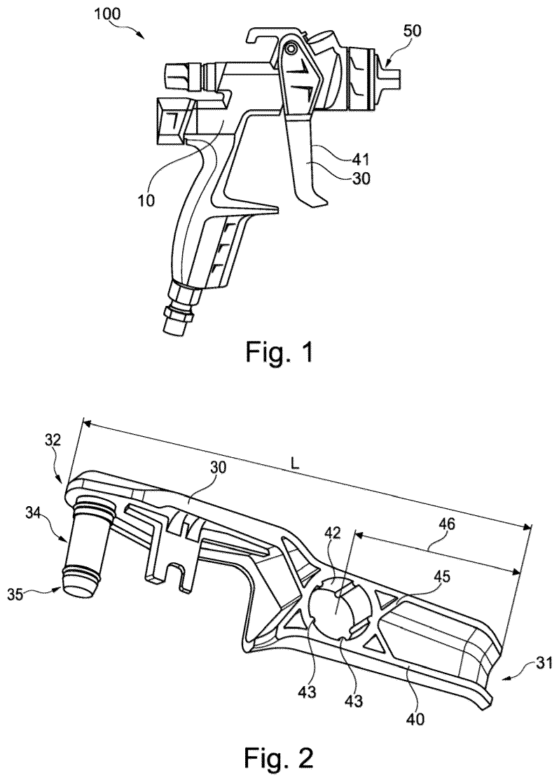

FIG. 1 shows an exemplary paint spray gun 100 according to the invention. The paint spray gun 100 comprises a paint spray gun body 10. The paint spray gun body 10 is made of metal here, but can also be made of plastics material, and has a handle. Here for example a needle valve for applying paint and an air valve for releasing compressed air, a compressed air connection, and a paint connection are arranged in the paint spray gun body 10. The paint spray gun 100 further comprises a paint nozzle body 50, which is not visible in the present FIG. 1, since it is covered by an air cap and an air nozzle ring. The paint nozzle body 50 is detachably connected to the paint spray gun body 10 via a thread. The paint spray gun 100 further comprises a trigger element 30. The trigger element 30 is designed to be detachably connected to the paint spray gun body 10. For example, this detachable connection can be enabled via a plug or snap connection. The trigger element 30 is rotatably mounted via a bolt in a bore of the paint spray gun body 10, wherein the bore can have a sleeve. By actuating the trigger element 30, the needle valve for applying the paint and the air valve for releasing the compressed air are actuated. For this purpose, a user pulls the trigger element 30 towards the paint spray gun body 10 with a finger on a finger support surface 41 of the trigger element 30.

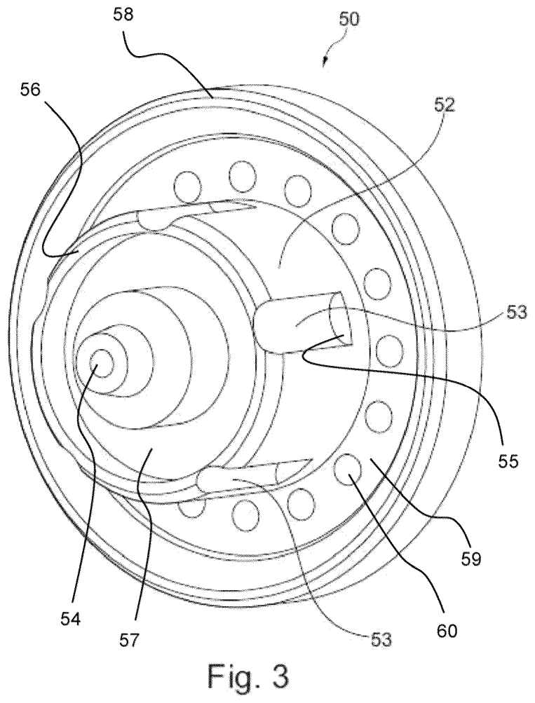

FIG. 2 shows an exemplary trigger element 30 according to the invention. The trigger element 30 is made of plastics material. The plastics material can be a fiber-reinforced plastics material. The plastics material is for example a polyamide. The fiber content is for example 50%. The trigger element 30 here has a tool inner contour 42. The tool inner contour 42 is designed to be brought into engagement with a workpiece outer contour 52 of the paint nozzle body 50 so that the paint nozzle body 50 can be removed from the paint spray gun body 10 and/or mounted on the paint spray gun body 10. The tool inner contour 42 here has a bore. The tool inner contour 42 here has five protrusions 43. The five protrusions 43 are evenly distributed over the circumference. The tool inner contour 42 is arranged on a side facing away from the finger support surface 41. The trigger element 30 has a first end 31 and a second end 32. The distance between the first end 31 and the second end 32 defines a longitudinal extension length L. The tool inner contour 42 is here arranged approximately 40% of the longitudinal extension length L from the first end 31. The length 46 corresponds to this 40%, measured from the first end 31. The trigger element 30 further comprises a bolt 34 with a snap counter-geometry 35. The bolt 34 is designed to be pushed into a bore (not shown) of the paint spray gun body 10 to allow for a rotatable mounting of the trigger element 30. The snap counter-geometry 35 secures the bolt 34 against being pulled out. The snap counter-geometry 35 is here designed as a retaining ring. The tool inner contour 42 and the trigger element body 40 are here formed integrally in one piece. The trigger element 30 here has stiffening ribs 45 which are connected to an outer region of the tool inner contour 42.

FIG. 3 shows an exemplary paint nozzle body 50 according to the invention. The paint nozzle body 50 has a workpiece outer contour 52. The workpiece outer contour 52 is here designed as a cylinder. The workpiece outer contour 52 here has five recesses 53 which are evenly distributed over the circumference. The workpiece outer contour 52 is designed to be brought into engagement with the tool inner contour 42 so that the paint nozzle body 50 can be removed from the paint spray gun body 10 and/or mounted on the paint spray gun body 10. The paint nozzle body 50 has an outlet opening 54 for the outlet of the material to be sprayed. The recesses 53 have a stop surface 55 at their end facing away from the outlet opening 54 of the paint nozzle body 50. This stop surface can serve as a stop for the tool for mounting and/or removing the paint nozzle body 50 to or from the paint spray gun body 10. The paint nozzle body 50 has a first collar 56 radially spaced from the outlet opening 54 of the paint nozzle body 50. A first notch 57 is arranged in the radial direction between the outlet opening 54 of the paint nozzle body 50 and the first collar 56. Here, this is a kind of circumferential trench between the outlet opening 54 and the first collar 56. The first notch 57 can for example accommodate part of the tool for mounting and/or removing the paint nozzle body 50 to or from the paint spray gun body 10. The first notch 57 can additionally or alternatively have another purpose, however. The recesses 53 penetrate the first collar 56 in the radial direction by 50% to 90%. This means that the recesses 53 extend through 50% to 90% of the thickness of the first collar 56. In this way, a sufficient hold can be ensured for the tool for mounting and/or removing the paint nozzle body 50 to or from the paint spray gun body 10. The paint nozzle body 50 has a second collar 58 radially spaced from the first collar 56. The second collar 58 can serve, in addition to or alternatively to the stop surfaces 55, as a stop for the tool for mounting and/or removing the paint nozzle body 50 to or from the paint spray gun body 10. The second collar 58 can, for example, provide a seal between an atomizing air region and a shaping air region of the paint spray gun. A second notch 59 can be arranged between the first collar 56 and the second collar 58. The second notch 59 can have through-bores 60, in particular for air, in particular for atomizing air.

### REFERENCE SIGNS

10 Paint spray gun body
30 Trigger element
31 First end of the trigger
32 Second end of the trigger
34 Bolt
35 Snap counter-geometry on the trigger
40 Trigger element body
41 Finger support of the trigger element
42 Tool inner contour of the trigger element
43 Protrusion on the tool inner contour
45 Stiffening ribs
46 Length
50 Paint nozzle body
52 Workpiece outer contour of the paint nozzle body
53 Recess on the workpiece inner contour
54 Outlet opening
55 Stop surface
56 First collar
57 First notch
58 Second collar
59 Second notch
60 Through-bores
100 Paint spray gun
L Longitudinal extension length of the trigger body/trigger element

1-23. (canceled)

24. A paint spray gun comprising:
a paint spray gun body;
a paint nozzle body which can be detachably fastened to the paint spray gun body;
a trigger element which is designed to be detachably connected to the paint spray gun body;
wherein the trigger element has a tool inner contour;
wherein the paint nozzle body has a workpiece outer contour corresponding to the tool inner contour of the trigger element;
wherein the trigger element is designed to be removed from the paint spray gun body; and
wherein the tool inner contour is designed to be brought into engagement with the workpiece outer contour of the paint nozzle body in such a way that the paint nozzle body can be removed from the paint spray gun body and/or the paint nozzle body can be mounted on the paint spray gun body.

25. The paint spray gun according to claim 24, wherein the trigger element has a finger support surface and the tool inner contour extends away from a side opposite the finger support surface.

26. The paint spray gun according to claim 24, wherein the trigger element has a first end and a second end, as well as a longitudinal extension length between the first end and the second end, and the tool inner contour is arranged away from both the first end and the second end of the trigger element by a distance of at least 25% of the longitudinal extension length.

27. The paint spray gun according to claim 24, wherein the tool inner contour has a polygonal inner contour, and the workpiece outer contour has a corresponding polygonal outer contour, wherein the inner contour and the corresponding outer contour are designed to be brought into engagement.

28. The paint spray gun according to claim 24, wherein the tool inner contour has a plurality of protrusions and the workpiece outer contour has a corresponding plurality of recesses, wherein the protrusions and the recesses are designed to be brought into engagement.

29. The paint spray gun according to claim 28, wherein the number of protrusions or recesses is at least four.

30. The paint spray gun according to claim 28, wherein the plurality of protrusions is evenly distributed over a circumference of the tool inner contour and the plurality of recesses is evenly distributed over a circumference of the workpiece outer contour.

31. The paint spray gun according to claim 24, wherein the trigger element has stiffening ribs which are connected to an outer region of the tool inner contour.

32. The paint spray gun according to claim 24, wherein the trigger element has a trigger element body with which the tool inner contour is integrally formed in one piece.

33. The paint spray gun according to claim 32, wherein the trigger element body formed integrally with the tool inner contour is made of a fiber-reinforced plastics material.

34. The paint spray gun according to claim 33, wherein the fiber-reinforced plastics material is a polyamide with a fiber content of at least 50%.

35. The paint spray gun according to claim 24, wherein the paint spray gun body has a snap geometry and the trigger element has a corresponding snap counter-geometry, wherein the snap geometry and the snap counter-geometry are designed for releasing and fixing the trigger element on the paint spray gun body.

36. A trigger element for a paint spray gun having a paint spray gun body and a paint nozzle body,
wherein the trigger element is designed to be detached from the paint spray gun body;
wherein the trigger element has a tool inner contour which is designed to be brought into engagement with a corresponding workpiece outer contour of the paint nozzle body, so that the paint nozzle body can be removed from the paint spray gun body and/or mounted on the paint spray gun body.

37. A paint nozzle body for a paint spray gun, the paint nozzle body comprising an outlet opening, wherein the paint nozzle body has a workpiece outer contour, wherein the workpiece outer contour has at least four recesses for receiving a tool.

38. The paint nozzle body according to claim 37, wherein the recesses have a stop surface at an end facing away from the outlet opening of the paint nozzle body.

39. The paint nozzle body according to claim 37, wherein the paint nozzle body has a first collar radially spaced from the outlet opening of the paint nozzle body.

40. The paint nozzle body according to claim 39, wherein the paint nozzle body has a first notch arranged in the radial direction between the outlet opening of the paint nozzle body and the first collar.

41. The paint nozzle body according to claim 39, wherein the recesses penetrate the first collar in the radial direction by 50% to 90%.

42. The paint nozzle body according to claim 39, wherein the paint nozzle body has a second collar radially spaced from the first collar.

43. The paint nozzle body according to claim 42, wherein the paint nozzle body has a second notch arranged in the radial direction between the first collar and the second collar.

44. The paint nozzle body according to claim 37, wherein the recesses have a radius of 1 mm to 2 mm and a height of 0.5 mm to 1.2 mm.
